(19) United States
(12) Patent Application Publication
(10) Pub. No.: US 2010/0024784 A1
(43) Pub. Date: Feb. 4, 2010

(54) Fuel oil pre-warming mechanism and its pre-warming method

(75) Inventor: Jerrey R. Lin, Taipei (TW)

Correspondence Address: The Weintraub Group, P.L.C., 28580 Orchard Lake Road, Suite 140, Farmington Hills, MI, 48334, US

(73) Assignee: Yung-Hsin Chen

(21) Appl. No.: 11/652,665

(22) Filed: Jan. 12, 2007

(30) Foreign Application Priority Data
Sep. 8, 2006 (TW) 095133181

(51) Int. Cl. F02M 31/16; F02G 5/00

(52) U.S. Cl. 123/557; 60/320; 165/52

(57) ABSTRACT

A fuel oil pre-warming mechanism for attaching to the exhaust pipe of an engine-based machine to pre-heat the fuel oil passing from the fuel tank to the engine of the engine-based machine is disclosed to include a heat guide, which has a hollow metal body sleeved onto the fuel pipeline and attached to the exhaust pipe, and a heat accumulation medium prepared from a heat resisting fluid and sealed in the hollow metal body for absorbing heat from the exhaust pipe through the heat guide during operation of the engine-based machine for heating the fuel oil passing through the fuel pipeline.

### BACKGROUND OF THE INVENTION

1. Field of the Invention

The present invention relates generally to fuel oil pre-warming mechanism, which is practical for use in an engine-based device, for example, car, motorcycle, or power generator to pre-heat the fuel oil. The invention also relates to a fuel oil pre-warming method using the fuel oil pre-warming mechanism.

2. Description of the Related Art

The engine and fuel oil system of a motor vehicle, as shown in FIG. 1, comprises a fuel tank A, an oil filter B connected to the fuel tank A to remove impurities from the fuel oil, an engine D, and a pump C connected between the oil filter B and the engine D and adapted to pump filtered fuel oil to the engine for mixing with air for combustion in the combustion chamber of the engine D. When fuel oil is ejected into a spray of fine drops and mixed with take air, the sparks produced by an ignition plug ignite the fuel mixture. During combustion of the fuel mixture in the combustion chamber of the engine D, an explosive cycle is repeated again and again to produce power that moves the moving parts of the motor vehicle. However, because the fuel oil is at a low temperature status having a high viscosity before entering the combustion chamber of the engine D, the spraying effect of the fuel oil is not satisfactory. Further, it takes a certain period of time to increase the temperature of the fuel oil from room temperature to the burning point. Burning the fuel mixture before the fuel oil reaches the burning point results in incomplete combustion, waste of fuel oil, accumulation of carbon in the engine, and shortening of the working life of the engine.

Therefore, delivering a room temperature fuel oil into an engine will encounter the problems of poor spraying effect, incomplete combustion, and engine carbon accumulation. Therefore, it is suggested to pre-heat the fuel oil before delivering it into the engine.

Taiwan, R. O. C. Patent Publication No. 474364 discloses a fuel oil pre-heater, which is to be installed in between the fuel tank and the engine combustion chamber. The fuel oil pre-heater comprises a hollow body, which defines therein an enclosed loop and has a series of teeth on at least one side of the inside wall of the enclosed loop, and two connectors respectively disposed at the front and rear sides relative to the enclosed loop for connection to the fuel tank and the engine combustion chamber respectively. Therefore, an internal loop and an external loop are formed in the fuel oil pre-heater.

According to the aforesaid design, the internal loop is for the passing of the pipeline of the water tank of the radiator of a motor vehicle, and the external loop is for the passing of the fuel pipeline of the motor vehicle. This structure of fuel oil pre-heater cannot be used in an engine-based machine without radiator, i.e., the fuel oil pre-heater is not usable in a motorcycle or small-scale power generator. Further, the radiator of a motor vehicle is for heat dissipation. If the medium, for example, water, in the water tank of the radiator is not at a high temperature, the fuel oil pre-warming effect of the fuel oil pre-heater is limited.

### SUMMARY OF THE INVENTION

The present invention has been accomplished under the circumstances in view. According to the present invention, the fuel oil pre-warming mechanism is attached to the exhaust pipe of an engine-based machine to pre-heat the fuel oil passing from the fuel tank to the engine of the engine-based machine, comprising a heat guide, which has a hollow metal body sleeved onto the fuel pipeline and attached to the exhaust pipe, and a heat accumulation medium prepared from a heat resisting fluid and sealed in the hollow metal body for absorbing heat from the exhaust pipe through the heat guide during operation of the engine-based machine for heating the fuel oil passing through the fuel pipeline.

Further, the end holes of the hollow metal body are sealed after extending of the fuel pipeline through the hollow metal body. The heat guide further comprises a pipe sleeved onto the fuel pipeline and connected between the two end holes of the hollow metal body.

Further, the hollow metal body has a contact surface disposed in contact with said exhaust pipe.

Further, the hollow metal body has an ejection port through which the heat accumulation medium is filled into the hollow metal body. The ejection port is sealed after filling of the heat accumulation medium into the hollow metal body.

The heat guide further comprises a packing member packed on the hollow metal body and the exhaust pipe to secure the hollow metal body to the exhaust pipe. The packing member is comprised of two symmetrical cover shells covered on the hollow metal body and the exhaust pipe and fixedly abutted against each other.

Further, the heat accumulation medium can be an engine oil or engine grease.

The invention also provides a fuel oil pre-warming method, which comprises the steps of a) preparing a fuel oil pre-warming mechanism, the fuel oil pre-warming mechanism comprising a heat guide, the heat guide having a hollow metal body, and a heat accumulation medium filled in the hollow metal body; and b) attaching the hollow metal body to the exhaust pipe of an engine-based machine to have the fuel pipeline of the engine-based machine extend through the heat accumulation medium in the hollow metal body for enabling the heat accumulation medium to absorb heat energy from the exhaust pipe through the hollow metal body and to heat the fuel oil passing through the fuel pipeline with the absorbed heat energy during operation of the engine-based machine.

Further, the hollow metal body is attached to the periphery of a part of the exhaust pipe that is the hottest part when heated by the exhaust gas of the engine-based machine.

The invention further comprises the step of fastening a packing member to the hollow metal body and the exhaust pipe to secure the hollow metal body to the exhaust pipe after the step b) of attaching the hollow metal body to the exhaust pipe. The packing member is comprised of two symmetrical cover shells.

### BRIEF DESCRIPTION OF THE DRAWINGS

FIG. 1 is a plain view of the engine and fuel oil system of a regular motor vehicle.

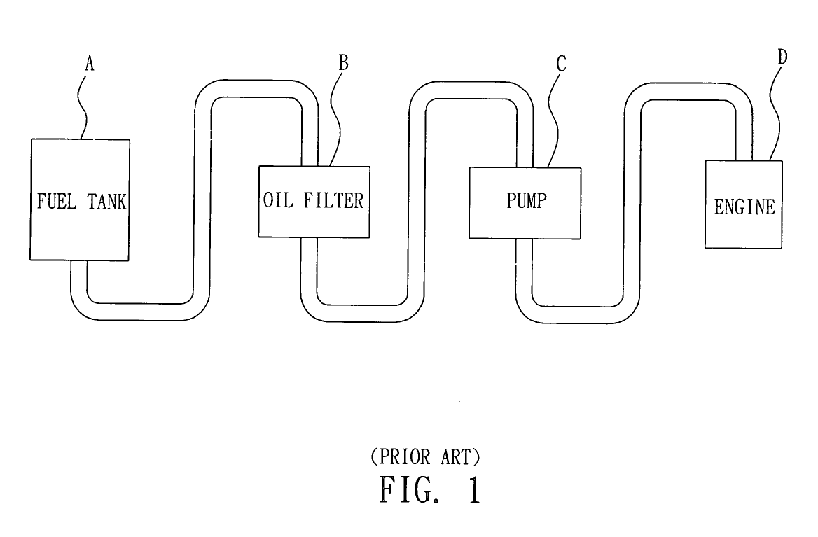

FIG. 2 is an exploded view of a fuel oil pre-warming mechanism according to the present invention.

FIG. 3a is a longitudinal sectional view of the present invention, showing the fuel oil pre-warming mechanism connected to the exhaust pipe and fuel pipeline of a motor vehicle.

FIG. 3b is a sectional view taken along line A-A of FIG. 3a.

FIG. 4 is a plain view showing an application example of the present invention.

### DETAILED DESCRIPTION OF THE INVENTION

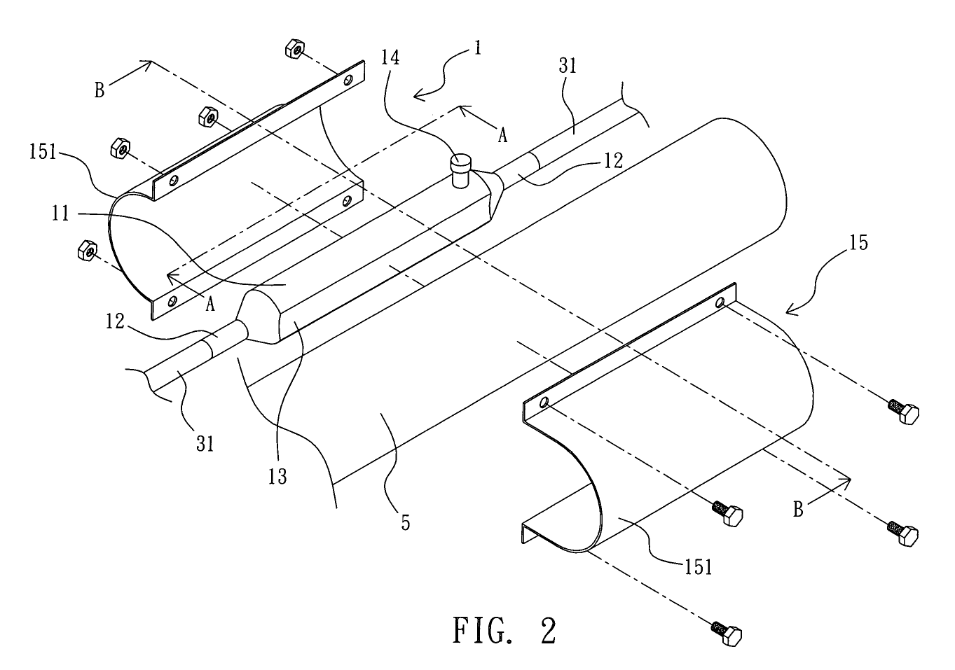

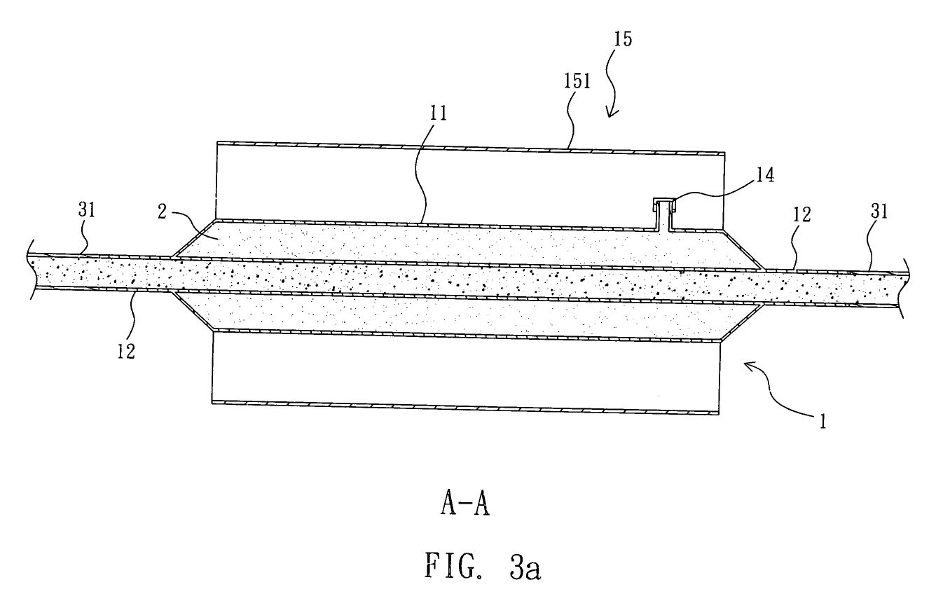

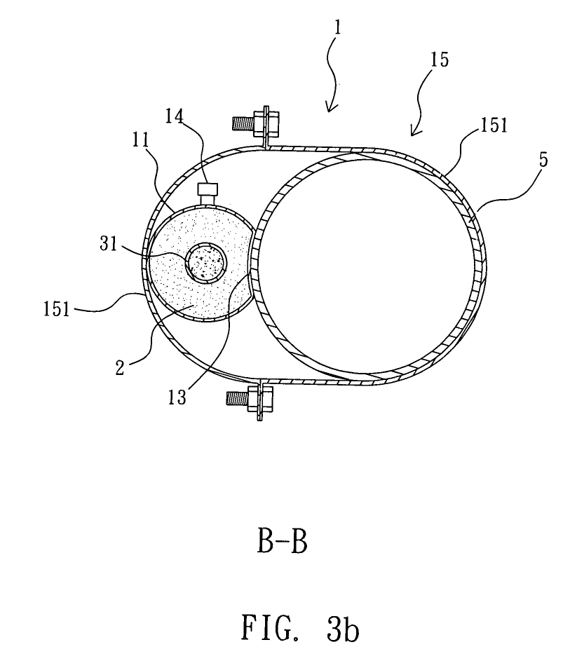

Referring to FIGS. 2, 3a and 3b, a fuel oil pre-warming mechanism in accordance with the present invention is shown comprised of a heat guide 1 and a heat accumulation medium 2. When in use, the fuel oil pre-warming mechanism is closely attached to the hottest section of the motor vehicle's exhaust pipe 5, i.e., the location near the exhaust port of the engine 4, for enabling the heat guide heat energy from the exhaust pipe 5 to the heat accumulation medium 2, which absorbs and accumulates heat energy to pre-warm the fuel pipeline 31 that extends through the heat guide 1.

The heat guide 1 comprises a hollow body 11 made of heat conducting metal, for example, copper alloy, having an end hole 12 at each of the two distal ends thereof for the passing of the fuel pipeline 31 that extends from the fuel tank 3. After insertion of the fuel pipeline 31 through the two end holes 12 of the body 11 of the heat guide 1, the gap in each end hole 12 around the fuel pipeline 31 is sealed to prevent leakage of the heat accumulation medium 2. Alternatively, a tube may be formed inside the heat guide 1 and connected between the two end holes 12 for the inaction of the fuel pipeline 31 directly.

In order to keep close contact between the body 11 and the exhaust pipe 5, the body 11 is made having contact surface 13 for direct contact of the exhaust pipe 5 to facilitate transmission of heat energy from the exhaust gas.

Further, the body 11 has an injection port 14 through which the liquefied or paste-like heat accumulation medium 2 is filled into the inside of the body 11. After filling of the heat accumulation medium 2, the injection port 14 is sealed either by a welding process or with a sealing cap, keeping the heat accumulation medium 2 in the body 11.

Further, after the body 11 has been closely attached to the periphery of the exhaust pipe 5, a packing member 15 is fastened to the body 11 and the exhaust pipe 5 to secure the body 11 firmly to the exhaust pipe 5 and to prevent quick dissipation of heat. As illustrated, the packing member 15 is comprised of two symmetrical cover shells 151 that are fastened together around the body 11 and the exhaust pipe 5 with fastening means, for example, screw bolts and nuts. The cover shells 151 each have a plurality of mounting through holes symmetrically disposed at two sides for the installation of the screw bolts.

The heat accumulation medium 2 is filled in the inside space of the body 11 to absorb and accumulate heat transferred through the body 11. Preferably, the heat accumulation medium 2 is obtained from heat resisting engine oil or grease for the advantage of high physical stability so that the heat accumulation medium 2 does not change its physical property when receiving and accumulating heat energy.

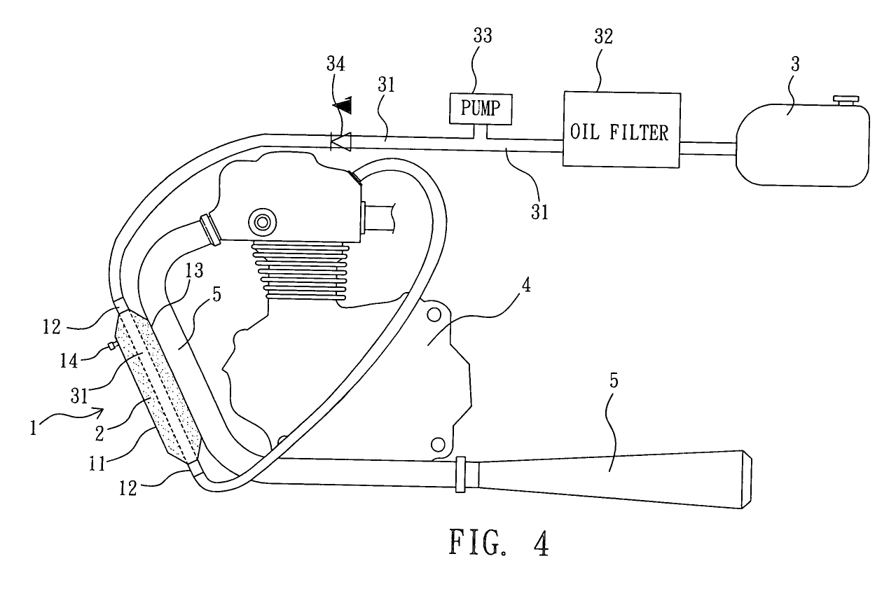

When in use, as shown in FIG. 4, the fuel oil pre-warming mechanism is closely attached to the hottest section of the exhaust pipe 5 near the exhaust port of the engine 4 of a motor vehicle, for example, a motorcycle. Of course, the invention can also be used in a car or small-scale power generator. When starting the engine 4, fuel oil is delivered through the fuel pipeline 31 to the engine 4 and then blended with air for combustion in the combustion chamber of the engine 4 to produce power for moving parts of the motorcycle, and at the same time exhaust gas thus produced is forced out of the engine 4 through the exhaust pipe 5. At this time, the fuel oil is continuously delivered from the fuel tank 3 through the fuel pipeline 31 to the oil filter 32 that removes impurities from the fuel oil, and a pump 33 pumps the filtered fuel oil to the engine 4. When the fuel oil is going through the fuel pipeline 31 surrounded by the body 11, it is heated by the heat energy that is accumulated in the heat accumulation medium 2. Because the body 11 keeps transferring heat energy about 350° C. from the exhaust pipe 5 to the heat accumulation medium 2, the fuel oil is heated by the heat energy accumulated in the heat accumulation medium 2 to maximum 110° c. when under room temperature 31° c. and when the motorcycle runs idle. The temperature of the exhaust gas at the exhaust port of the exhaust pipe 5 is about 60° C. When the motorcycle is running, the fuel oil pre-warming mechanism can heat the fuel oil to about 85° C. Because the fuel oil is warmed up by the fuel oil pre-warming mechanism, the viscosity of the fuel oil is lowered before entering the engine 4. Therefore, the fuel foil can be ejected into a spray of fine drips for mixing with air efficiently. As illustrated, a check valve 34 is installed between the pump 33 at the fuel pipeline 31 and the body 11 to prevent reverse flow of heated fuel oil to the fuel tank 3.

Based on the aforesaid statement, the fuel oil pre-warming method of the present invention includes the step of preparing a fuel oil pre-warming mechanism, which comprises a heat guide 1 having a body 11, and a heat accumulation medium 2 filled in the body 11, and the step of firmly attaching the body 11 to the exhaust pipe 5 of a motor vehicle to have the fuel pipeline 31 extend through the heat accumulation medium 2 of the fuel oil pre-warming mechanism for enabling the heat accumulation medium 2 to absorb heat energy from the exhaust pipe 5 through the body 11 of the heat guide 1 and to heat the fuel oil passing through the fuel pipeline with the absorbed heat energy during operation of the motor vehicle.

As indicated above, the application of the present invention pre-heats the fuel oil to lower its viscosity for spraying into a spray of fine drops efficiently for further missing with air for complete combustion in the engine of the motor. Therefore, the invention effectively saves fuel oil consumption and greatly improves the performance of the engine. Further, because the invention is to heat the fuel oil indirectly, i.e., not to heat the fuel oil with fire directly, the application of the present invention is safe. Further, because of complete combustion of the engine, the invention can reduce the production of carbon oxide and carbon dioxide by 50% and 30% respectively, thereby effectively eliminating accumulation of carbon and exhaust of black smoke, i.e., effective waste fuel oil in the exhaust gas is greatly reduced to prevent quick wearing of the engine and to prolong the working life of the engine.

A prototype of fuel oil pre-warming mechanism has been constructed with the features of FIGS. 2˜4. The fuel oil pre-warming mechanism functions smoothly to provide all of the features discussed earlier.

Although a particular embodiment of the invention has been described in detail for purposes of illustration, various modifications and enhancements may be made without departing from the spirit and scope of the invention. Accordingly, the invention is not to be limited except as by the appended claims.

What is claimed is:

1. A fuel oil pre-warming mechanism attached to an exhaust pipe of an engine-based machine for heating a fuel oil passing through a fuel pipeline extending between a fuel tank and an engine of said engine-based machine, comprising:
a heat guide, said heat guide comprising a hollow metal body, said hollow metal body having an end hole at each of two distal ends thereof for the passing of the fuel pipeline of said engine-based machine; and
a heat accumulation medium prepared from a heat resisting fluid and sealed in said hollow metal body of said heat guide for absorbing heat from said exhaust pipe during operation of said engine-based machine for heating the fuel oil passing through said fuel pipeline.

2. The fuel oil pre-warming mechanism as claimed in claim 1, wherein the end holes of said hollow metal body are sealed after extending of said fuel pipeline through said hollow metal body.

3. The fuel oil pre-warming mechanism as claimed in claim 1, wherein said heat guide further comprises a pipe sleeved onto said fuel pipeline and connected between the two end holes of said hollow metal body.

4. The fuel oil pre-warming mechanism as claimed in claim 1, wherein said hollow metal body has a contact surface disposed in contact with said exhaust pipe.

5. The fuel oil pre-warming mechanism as claimed in claim 1, wherein said hollow metal body has an ejection port through which said heat accumulation medium is filled into said hollow metal body, said ejection port being sealed after filling of said heat accumulation medium into said hollow metal body.

6. The fuel oil pre-warming mechanism as claimed in claim 1, wherein said heat guide further comprises a packing member packed on said hollow metal body and said exhaust pipe to secure said hollow metal body to said exhaust pipe.

7. The fuel oil pre-warming mechanism as claimed in claim 6, wherein said packing member is comprised of two symmetrical cover shells covered on said hollow metal body and said exhaust pipe and fixedly abutted against each other.

8. The fuel oil pre-warming mechanism as claimed in claim 1, wherein said heat accumulation medium is prepared from one of an engine oil and an engine grease.

9. The fuel oil pre-warming mechanism as claimed in claim 1, further comprising a check valve installed in said fuel pipeline between said hollow metal body and said fuel tank.

10. A fuel oil pre-warming method comprising the steps of:
a) preparing a fuel oil pre-warming mechanism, said fuel oil pre-warming mechanism comprising a heat guide, said heat guide having a hollow metal body, and a heat accumulation medium filled in said hollow metal body; and
b) attaching said hollow metal body to the exhaust pipe of an engine-based machine to have the fuel pipeline of said engine-based machine extend through said heat accumulation medium in said hollow metal body for enabling said heat accumulation medium to absorb heat energy from the exhaust pipe through said hollow metal body and to heat the fuel oil passing through the fuel pipeline with the absorbed heat energy during operation of the engine-based machine.

11. The fuel oil pre-warming method as claimed in claim 10, wherein said heat accumulation medium is prepared from one of an engine oil and an engine grease.

12. The fuel oil pre-warming method as claimed in claim 10, wherein said hollow metal body is attached to the periphery of a part of said exhaust pipe that is the hottest part when heated by the exhaust gas of the engine-based machine.

13. The fuel oil pre-warming method as claimed in claim 10, further comprising the step of fastening a packing member to said hollow metal body and said exhaust pipe to secure said hollow metal body to said exhaust pipe after the step b) of attaching said hollow metal body to said exhaust pipe.

14. The fuel oil pre-warming method as claimed in claim 13, wherein said packing member is comprised of two symmetrical cover shells.
